(19) United States
(12) Patent Application Publication
(10) Pub. No.: US 2011/0246097 A1
(43) Pub. Date: Oct. 6, 2011

(54) Method and System for Determining Aerodynamic Loads from Leading Edge Flow Parameters

(76) Inventor: Arun Mangalam, Williamsburg, VA (US)

(21) Appl. No.: 13/076,901

(22) Filed: Mar. 31, 2011

Related U.S. Application Data
(60) Provisional application No. 61/319,303, filed on Mar. 31, 2010.

(51) Int. Cl. G01L 5/00; G06F 19/00

(52) U.S. Cl. 702/43; 702/41

(57) ABSTRACT

A method is provided for determining an aerodynamic coefficient for a body immersed in a fluid under a set of fluid flow conditions. The method comprises obtaining surface flow parameter data for a plurality of locations on the body. These locations include body surface points straddling an area of the body surface where a leading edge stagnation point (LESP) is expected to be located. The method further comprises determining the LESP location and an angle of attack of the body with respect to freestream conditions of the fluid using the flow parameter data. The method also comprises determining the aerodynamic coefficient from the LESP location and the angle of attack using an aerodynamic model.

### CROSS-REFERENCE TO RELATED APPLICATIONS

This application claims priority to U.S. Provisional Application No. 61/319,303, which was filed Mar. 31, 2010 and is incorporated herein by reference in its entirety.

### FIELD OF THE INVENTION

The invention relates generally to the determination of aerodynamic and hydrodynamic loads and, more particularly, to the real time determination of fluid flow parameters and load coefficients for a body immersed in a flow regime using sensor data in the vicinity of a single critical location on the body.

### BACKGROUND OF THE INVENTION

Determination of aerodynamic forces and moments on an aircraft is critical to aircraft design. Aerodynamic loads and moments predicted by theoretical models, however, generally differ from the loads and moments experienced under actual flight conditions, largely due to the dominating role of viscous effects and their interactions with the structure.

As described in U.S. Pat. No. 6,826,493 ('493 Patent) and U.S. Pat. No. 6,963,810 ('810 Patent), the complete disclosures of which are incorporated herein by reference in their entirety, methods have been developed to relate aerodynamic loads and moments to flow data that can be measured without regard to structural response. These methods involve correlating aerodynamic loads and moments to the spatial locations of critical flow feature indicators (CFFIs), which are associated with certain flow phenomena such as flow bifurcation points, shock waves, and the transition from laminar to turbulent flow. As used herein, the term “flow bifurcation point” (FBP) means a location on a body surface where the flow attaches to or separates from the body. As illustrated in FIG. 1, the FBPs associated with an airfoil 10 may include leading edge stagnation point (LESP) 20, flow separation point (FSP) 30, and flow reattachment point (FRP). The '493 and '810 Patents also described how the CFFIs associated with these phenomena can be determined from shear stress and convective heat transfer data obtained from hot film sensors formed on or adhered to the surface of a body immersed in steady or unsteady flow regimes.

In U.S. patent application 12/499,324 ('324 Application), filed Jul. 8, 2009, the complete disclosure of which is incorporated herein by reference in its entirety, methods are disclosed for modeling aerodynamic forces and moments using FBPs and other CFFIs. In particular, the '324 Application discloses a mathematical model based on potential flow theory combined with conformal transformation. Among other approaches, the model allows the computation of aerodynamic coefficients based on the specification of two FBPs (e.g., LESP and FSP) for a given flow regime.

The above-cited references describe methods for measuring flow parameters and computing aerodynamic coefficients and loads in real time for immersed bodies. Embodiments of the present invention extend these methods to provide robust and efficient methods of providing aerodynamic and hydrodynamic load information based on relatively limited sensor data.

It will be understood by those of ordinary skill in the art that the methods of the present invention apply to all fluid flow regimes. Thus, although the term “aerodynamic” is used throughout in describing the embodiments of the invention, the invention may also be used in hydrodynamic applications or applications involving any other fluid flow regime.

### SUMMARY OF THE INVENTION

An illustrative aspect of the invention provides a method of determining an aerodynamic coefficient for a body immersed in a fluid under a set of fluid flow conditions, wherein the flow conditions establish an LESP at an LESP location on the body. The method comprises obtaining surface flow parameter data for a plurality of locations on the body. These locations include body surface points straddling an area of the body surface where the LESP is expected to be located. The method further comprises determining the LESP location and an angle of attack of the body with respect to freestream conditions of the fluid using the flow parameter data. The method also comprises determining the aerodynamic coefficient from the LESP location and the angle of attack using an aerodynamic model.

### BRIEF DESCRIPTION OF THE DRAWINGS

The invention can be more fully understood by reading the following detailed description together with the accompanying drawings, in which like reference indicators are used to designate like elements, and in which:

FIG. 1 is a schematic representation of the flow around a wing section;

FIG. 2 is a flow diagram of a method for determining aerodynamic coefficients and loads according to an embodiment of the invention;

FIG. 3 is an illustration of two shear stress profiles in the vicinity of the leading edge of an airfoil;

FIG. 4 illustrates the change (loss) in lift coefficient as a function of LESP recession;

FIG. 5 illustrates a comparison of model output to measured data for lift coefficient versus angle of attack;

FIG. 6 is a flow diagram of a method for determining aerodynamic coefficients and loads according to an embodiment of the invention; and

FIG. 7 is a schematic representation of a system for determining aerodynamic coefficients and loads according to an embodiment of the invention.

### DETAILED DESCRIPTION OF THE INVENTION

While the invention will be described in connection with the preferred embodiment, it will be understood that it is not intended to limit the invention to those embodiments. On the contrary, it is intended to cover all alternatives, modifications and equivalents that may be included within the spirit and scope of the invention as described.

As discussed above. previous patents and patent applications describe techniques for estimate aerodynamic coefficients (e.g., lift coefficient (CL), moment coefficient (CM) and drag coefficient (CD) as a function of the locations of the multiple FBPs of a body immersed in a fluid under various flow conditions. The present invention provides methods of estimating these coefficients based on sensor information in the vicinity of a single FBP. In particular, the method provides aerodynamic coefficients of a body such as an airfoil based on flow data obtained in the vicinity of the leading edge of the airfoil. These coefficients in combination with measured flow data allows the real-time determination of loads on the body, which can be used in various ways including but not limited to aircraft control, structural configuration control, and warning systems.

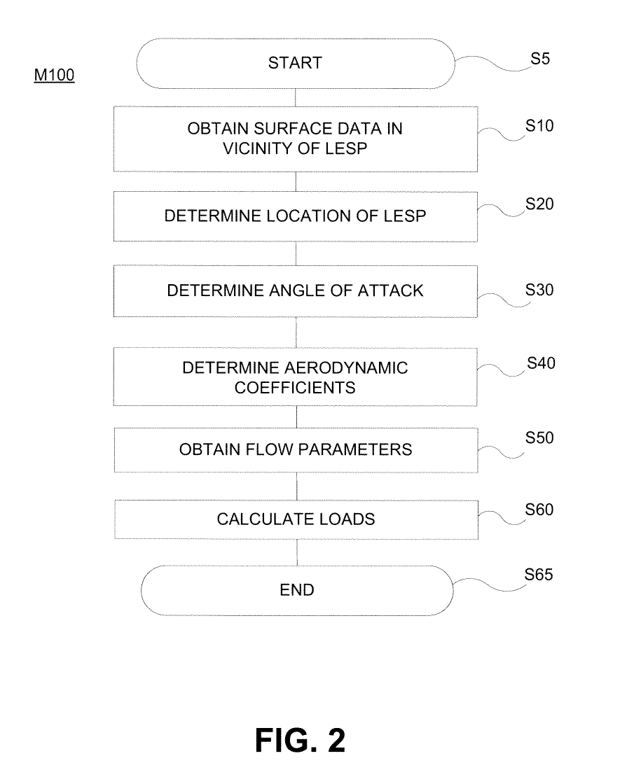

With reference to FIG. 2 a generalized method M100 may be used to determine one or more aerodynamic coefficients and associated loads for a body immersed in a fluid under a set of flow conditions. The method M100 begins at S5 and at S10 data regarding the flow around the surface in the vicinity of the expected LESP are obtained. These data may be, for example, static pressure or shear stress measurements at spaced apart locations intended to bracket the expected LESP location. In a particular embodiment, the data are shear stress measurements obtained using thin film sensors such as those described in U.S. Pat. Nos. 5,218,863 and 6,134,959, the complete disclosures of which are incorporated herein by reference in their entirety.

At S20, the leading edge flow data are used to determine the location of the LESP. This may be accomplished using a method like those disclosed in the '493 and '810 Patents. At S30, the leading edge flow data are used to determine the angle of attack (AoA) of the body with respect to the freestream. As will be discussed in more detail below, this may be accomplished in conjunction with the determination of the LESP location using a mapping technique and the identification of local maxima of the measured surface flow parameter.

Once the LESP location and the AoA have been determined, an aerodynamic model is used at S40 to determine one or more aerodynamic coefficients such as CL, CM and CD. The aerodynamic model may be one of an analytical model, an empirical model or a semi-empirical model, each of which is discussed in more detail below.

At S50, flow parameters are specified or otherwise obtained. The flow parameter input may include information such as freestream velocity, Reynolds numbers, kinematic viscosity, and related parameters. At S60, standard techniques are used to calculate aerodynamic loads on the body using flow parameters and the previously determined aerodynamic coefficients. The aerodynamic loads can then be provided to a control system, warning system, or data acquisition system. The method ends at S65.

As discussed above, the method M100 uses measured surface data to determine the LESP location and the AoA. As is discussed in the '493 Patent, shear stress and/or other data may be mapped to the surface of a body for use in identifying FBPs. The LESP, for example, may be determined by locating a minimum shear stress at or near the leading edge of the body. This minimum is indicative of the flow stagnation conditions that occur at the LESP. Similar results may be accomplished using pressure measurements.

The present invention provides a particular approach to the use of the mapped surface data to determine LESP location and also provides a method of determining AoA. In the examples used to describe this approach, shear stress is used as the measured surface parameter. It will be understood that other measured surface parameters may be used as well. In this embodiment of the invention, the measured surface shear stress(or other parameter) at several points along the chord can be fitted to a curve representing a theoretical profile that allows the flow bifurcation point to be determined. Near the stagnation point region, there is a shear stress minimum near the leading edge stagnation point (LESP) and there is a sharp rise in shear away from the LESP. As is well known, the flow stagnates at LESP and therefore the shear is low and just away from the LESP, the flow is rapidly accelerating, increasing the local shear. With several sensors in the LESP region, it is possible to fit the dimensional shear stress data to shear stress profile that has a sharp cusp.

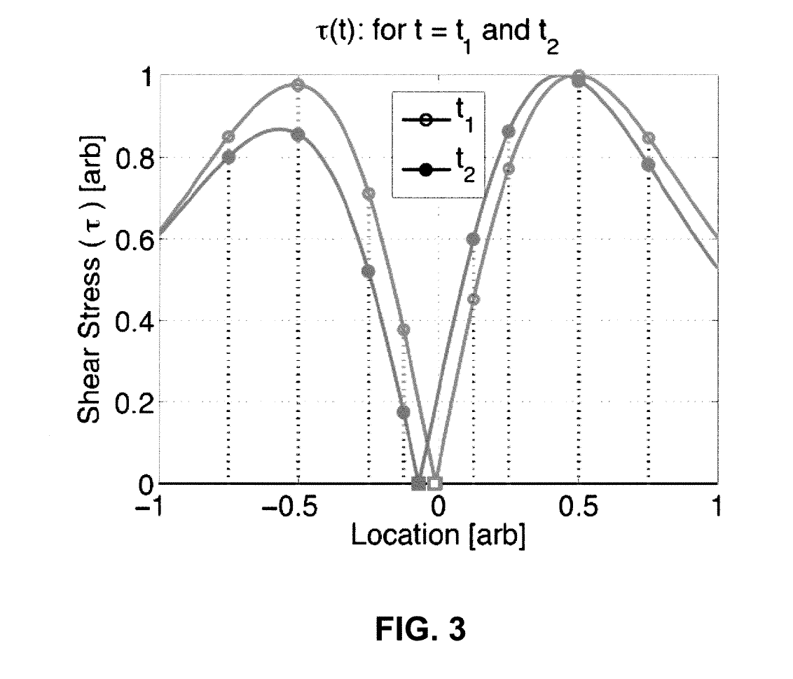

FIG. 3 illustrates measured shear stress as a function of distance from a reference location at the leading edge of an airfoil. The zero location represents the leading-edge of the airfoil. Two sets of data are plotted, one for each of two consecutive measurement times, t1 (open symbols) and t2 (closed symbols). The differences between the two plots result from a change in flow conditions (e.g., angle of attack or flow separation location)) from t1 to t2. On each curve, the point represented by a square is at zero shear stress, and thus identifies the location of the stagnation point at that time. In addition to the minimum point, each curve also has two maximum points (maxima). It has been found that the locations of these three extrema uniquely define, not only the LESP, but the effective angle of attack as well.

It should be noted that it may be possible to obtain t o different LESP locations for the same AoA, if the downstream conditions have changed (e.g., flow separation has moved). In a recent experiment (see J. Poggie, C. Tilmann, P. Flick, J. Silkey, B. Osborne, G. Ervin, D. Marie, S. Mangalam, and A. Mangalam, “Closed-loop stall control system,” Journal of Aircraft, vol. 47, no. 5, Sep. 2010), plasma actuators were used to move flow separation point to increase lift. As the flow separation point changed, the LESP location moved as well, corresponding to an increase in lift for the same angle of attack. So, the LESP location will change if there is a change in flow separation location or angle of attack. In the case of fully attached flow, the LESP movement will directly correspond with the angle of attack. However, in reality, there is flow separation and other adverse flow conditions.

The exact locations of the extrema for data such as that shown in FIG. 3 may be identified by: (1) phase reversal techniques or (2) comparison of the measured shear stress and its spatial/time derivatives with the expected shear stress profile and spatial/time derivatives for various stagnation point and angles as determined through a flow model.

For phase reversal, the assumption is that the flow is always oscillating, and when an extremum oscillates, the sensors on either side are out of phase. This phase signature uniquely bounds the location of the extremum based on the sensor locations without requiring any a priori calibration.

For the comparison method, measured shear stress profiles based on the stagnation point location and AoA may be stored. The actual measured shear stress profile may then be compared with the profiles of the stored profiles to find the profile(s) with the least difference in shape. The comparison may be formulated in terms of an optimization problem to find the closest shear stress shape. Once the closest shape is found, the associated stagnation point and effective angle of attack are determined.

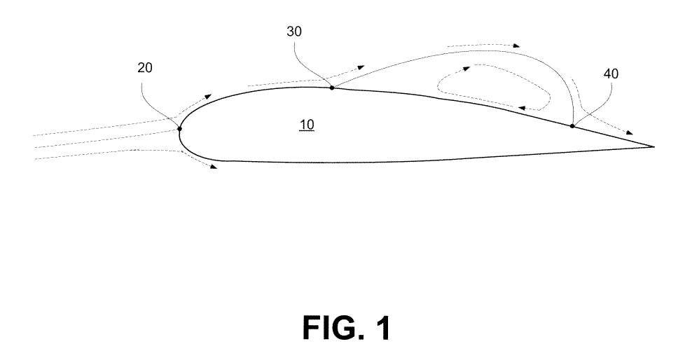

It will be understood that this technique is not limited to shear stress profiles. It may also be applied to other flow measurements such as pressure profiles. For example, the surface velocity distribution is similar in appearance to the shear stress profile. The surface velocity distribution could be measured using surface pressure sensors. Using an array of pressure sensors along the surface, the surface pressure gradient, dP/dx, may be estimated by subtracting the output from adjacent pressure sensors. The result would be a curve similar to that of the shear stress profile, except that the output will not be all positive like the measured shear stress output from hot-film sensors. Regardless, the absolute value of dP/dx, will provide three extrema similar to those seen in FIG. 1 for the shear stress. As with the shear stress profile, the extrema locations are unique to a specific stagnation point location and effective angle of attack.

Under certain circumstances, angle of attack information may be available from a separate source. For example, angle of attack may be obtained from an air data probe or boom or from inertial measurements. In such cases, the flow parameter profile derived from the shear stress or other data obtained near the leading edge need only be used to obtain the LESP location. Once determined, the LESP location may be combined with the angle of attack from the other source for use in determining the aerodynamic coefficient.

Once the LESP and AoA are determined for a particular time, an aerodynamic model may be used to determine the aerodynamic coefficients of the body at that time. As noted above, this model may be generated using one of three approaches. A first approach is to experimentally determine the relationship of each coefficient to LESP and AoA under various conditions. This would typically involve instrumenting the wing or other body with sensors to determine the shear stress (or other surface parameter) profile under various flow and AoA conditions. The profiles could then be used to determine LESP location and AoA. Using standard instrumentation and analysis techniques, the aerodynamic coefficients can also be determined. The LESP, AoA and aerodynamic coefficients can be determined for a range of AoAs at a given Reynolds number. Using the acquired data, a two parameter function f(LESP, AoA) can be determined whose value is an aerodynamic coefficient (CL, CD or CM). This function can then be used in the method of FIG. 2.

A second method of the invention provides a semi-empirical approach to the generation of an aerodynamic model. this method uses a comparison of the experimentally obtained data to an inviscid numerical solution for the body under the same flow conditions. The first step is to calculate the analytical/numerical inviscid solution for the given body geometry at various angles of attack. The LESP location and aerodynamic coefficient for each inviscid solution (i.e., at each AoA) can then be calculated. The difference between the LESP location calculated using the inviscid solution and the LESP location determined from experimental data can then be found for each AoA. This difference is referred to herein as “LESP recession.” The difference between the aerodynamic coefficient calculated using the inviscid solution and the aerodynamic coefficient determined from experimental data is then calculated for each AoA. This is referred to herein as “change in aerodynamic coefficient.” A mathematical fit between the LESP recession and the change in aerodynamic coefficient can then be established. The resulting mathematical fit can be used to generate a function of LESP and AoA whose value is the aerodynamic coefficient.

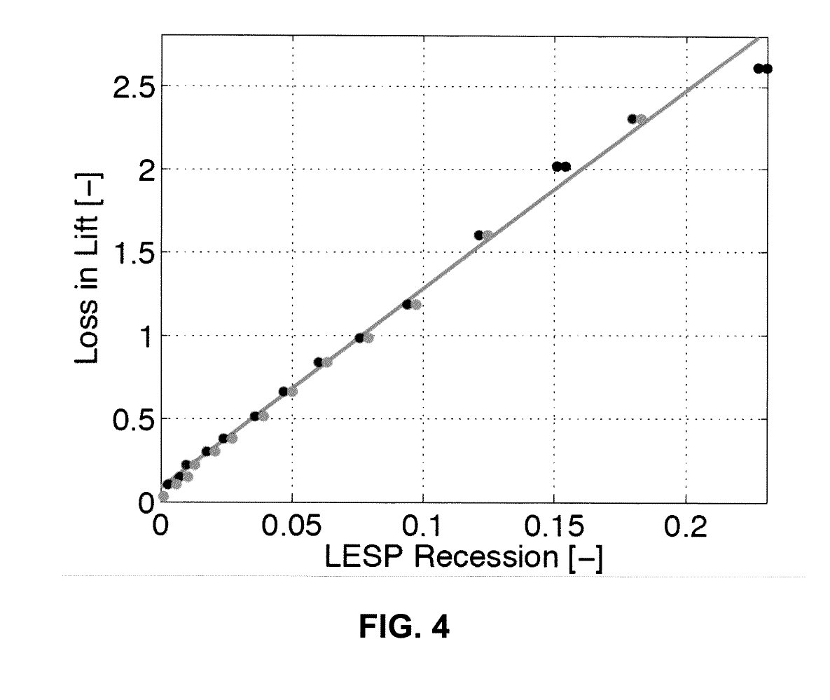

FIG. 4 is a plot of the LESP recession versus the difference in lift coefficient CL for a cambered airfoil. The measured data were obtained through wind tunnel testing at the Subsonic Aeronautics Research Laboratory at Wright-Patterson Air Force Base. As this plot shows, the relationship is nearly linear, so a first order polynomial with slope K and no offset provides an adequate fit. At a given AoA, LESP_I(AoA) and AC_I(AoA) are the LESP location and aerodynamic coefficient for the inviscid solution, respectively, and LESP_M(AoA) and AC_M(AoA) are the measured LESP location and aerodynamic coefficient, respectively. It can be seen that the relationship between the aerodynamic coefficient and LESP is

AC_{—}I(AoA)−AC_{—}M(AoA)=K*[LESP_{—}I(AoA)−LESP_{—}M(AoA)]

Therefore, to estimate the aerodynamic coefficient, AC, at a given AoA and LESP location,

AC(AoA, LESP_{—}M(AoA))=AC_{—}I(AoA)−K[LESP_{—}I(AoA)−LESP_{—}M(AoA)]

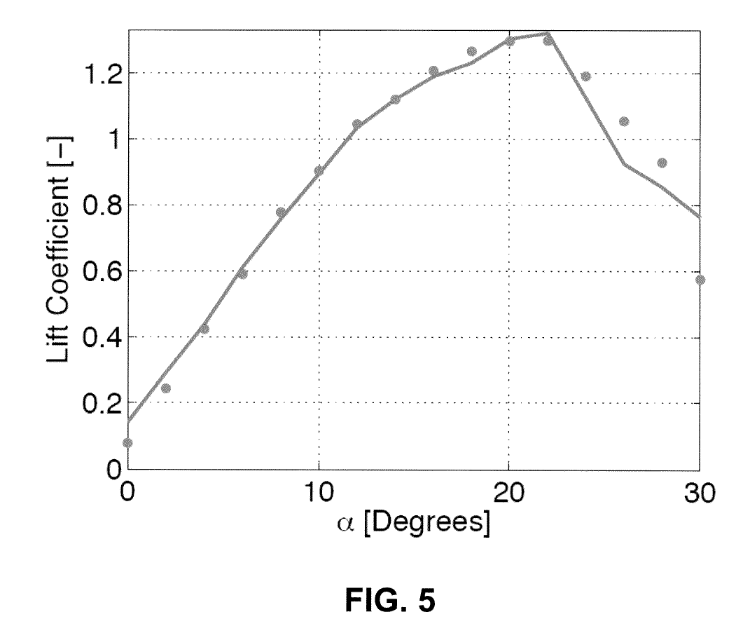

This function can then be used in conjunction with the inviscid model to obtain the aerodynamic coefficient for any LESP and AoA. FIG. 5 illustrates a comparison of the adjusted inviscid solution resulting from the above-described method (solid line) to measured data (dots) for a cambered airfoil.

It is also possible to obtain an aerodynamic model using analytical techniques alone. For example, a model may be constructed based on running virtual experiments using a Navier-Stokes simulation. Other techniques could include those described in the '324 Application.

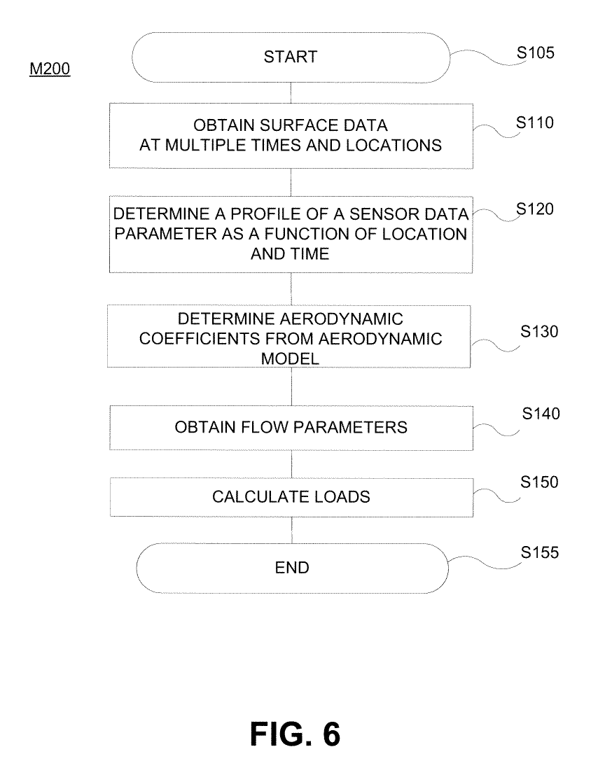

Embodiments of the invention may also use methods that directly relate the output distribution of surface sensors to aerodynamic coefficients. With reference to FIG. 6, a method M200 for determining aerodynamic coefficients and resultant loads begins at S115. At S110, data regarding the flow around the surface in the vicinity of the expected LESP are obtained. These data may be, for example, static pressure or shear stress measurements at spaced apart locations intended to bracket the expected LESP location. In this embodiment, the data are obtained at multiple times for each flow condition. As before, the data may be shear stress measurements obtained using thin film sensors such as those described in U.S. Pat. Nos. 5,218,863 and 6,134,959.

At S120, the surface flow parameter data are used to determine a flow parameter profile. This profile is essentially a distribution of the flow parameter as a function of spatial location, x and time, t. This profile, s(x, t), can be provided as input at S130 to an aerodynamic model for use in computing one or more aerodynamic coefficients. At S140, flow parameters are specified or otherwise obtained. The flow parameter input may include information such as freestream velocity, Reynolds numbers, kinematic viscosity, and related parameters. At S150, standard techniques are used to calculate aerodynamic loads on the body using flow parameters and the previously determined aerodynamic coefficients. The aerodynamic loads can then be provided to a control system, warning system, or data acquisition system. The method ends at S155.

As in the earlier methods, the aerodynamic model used in the method M200 may be empirical, analytical or semi-empirical. In a particular embodiment, experimental data are used to obtain sensor profiles s(x, t) and associated aerodynamic coefficients for a range of angles of attack at a particular Reynolds number. Using the acquired data, a function f(s(x, t), x, t) can be constructed whose value is an aerodynamic coefficient (CL, CD or CM). This function can then be used to determine the aerodynamic function in real time based on in-flight data measurements.

In a particular embodiment, the function f(s(x, t), x, t) can be determined by obtaining locations of local extrema in s(x, t). These local extrema can then be used to determine LESP and AoA using the methods previously described. A function for the aerodynamic coefficients can then be determined based on the aerodynamic modeling approaches previously discussed.

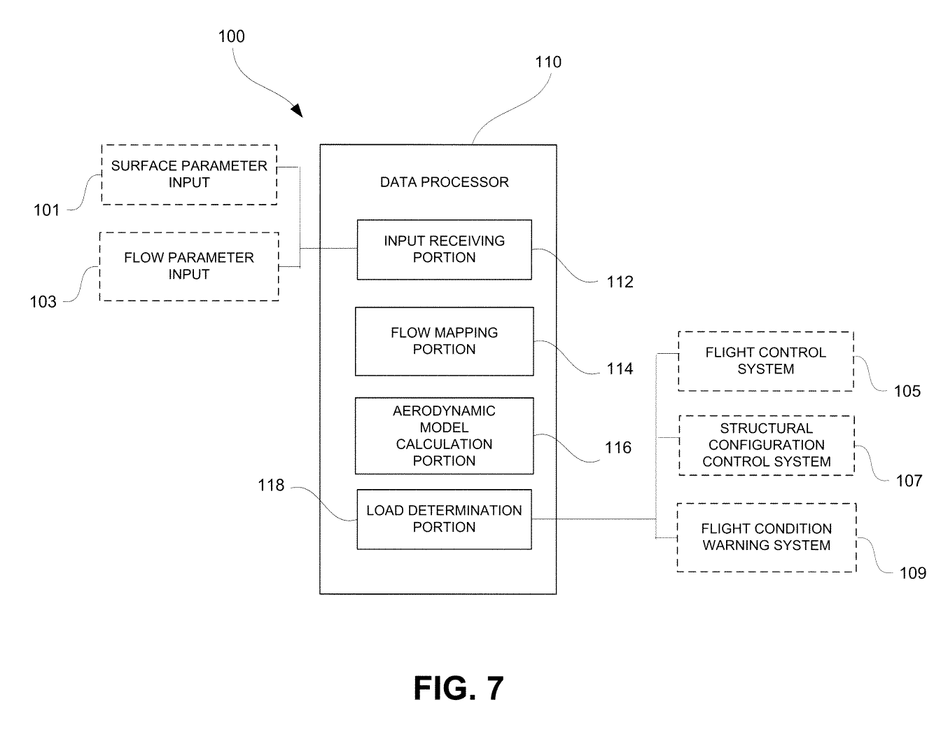

FIG. 7 depicts a processing system 100 configured for determining aerodynamic coefficients for a body immersed in a flow regime in accordance with various embodiments of the invention. The system 100 includes a data processor 110 having an input receiving portion 112, an LESP computation portion 114, an aerodynamic model calculation portion 116 and a load determination portion 118. The input receiving portion 112 is configured for receiving surface parameter input 101 and flow parameter input 103, which may be obtained from a data acquisition system (not shown). The data acquisition system may include sensors (e.g., hot film sensors, pressure sensors or other types of sensors capable of measuring tangential or normal forces) for obtaining surface parameter data and/or flow parameter data. Some or all of the sensors in the data acquisition system may be incorporated into arrangements such as the constant voltage anemometer (CVA) arrangement described in the '493 and '810 Patents. The input receiving portion 112 may be configured to process (or further process) the inputs 101, 103. The flow parameter input 103 may include freestream velocity, Reynolds numbers, kinematic viscosity, and related parameters. The input receiving portion 112 may alternatively be configured for receiving the various inputs from a database or other source. The input receiving portion 112 may be further configured to store input data for multiple time values.

The flow mapping portion 114 is configured to receive surface parameter information from the input receiving portion and to use this information to map the flow near the leading edge of the body. The flow mapping portion 114 may be configured to determine the location of the LESP and the AoA using of the methods described herein for determining these parameters. Alternatively or in addition, the flow mapping portion may be configured to determine a flow profile function using data collected at multiple time steps. In either case, the resulting parameters are passed to the aerodynamic model calculation portion 116 for use in calculating one or more aerodynamic coefficients. The aerodynamic model calculation portion may be configured to use any of the aerodynamic models described herein. In all cases, the output is one or more coefficients, which may then be passed to a load determination portion, which uses the coefficients along with the flow parameter input data to calculate one or more aerodynamic loads on the body. These loads may then be passed, as desired or required to a flight control system 105, structural configuration control system and/or a flight condition warning system.

It will be understood that the data processor 110 may be any programmable data processing system and that the identified portions may be collocated in a single processing unit or may be distributed among multiple processing units.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its preferred embodiment, it is to be understood that this disclosure is only illustrative and exemplary of the present invention and is made merely for the purposes of providing a full and enabling disclosure of the invention. Many modifications to the embodiments described above can be made without departing from the spirit and scope of the invention. Accordingly, the foregoing disclosure is not intended to be construed or to limit the present invention or otherwise to exclude any other such embodiments, adaptations, variations, modifications and equivalent arrangements.

What is claimed is:

1. A method of determining an aerodynamic coefficient for a body immersed in a fluid under a set of fluid flow conditions, said flow conditions establishing a leading edge stagnation point (LESP) at an LESP location on the body, the method comprising:
obtaining surface flow parameter data for a plurality of locations on the body, said locations including body surface points straddling an area of the body surface where the LESP is expected to be located:
determining the LESP location using the flow parameter data;
determining an angle of attack of the body with respect to freestream conditions of the fluid; and
determining the aerodynamic coefficient from the LESP location and the angle of attack using an aerodynamic model.

2. A method according to claim 1 further comprising:
obtaining flow parameter data for the flow conditions; and
calculating a load on the body using the flow parameter data and the aerodynamic coefficient.

3. A method according to claim 1 wherein the surface flow parameter data includes one or more of the set consisting of shear stress data and pressure data.

4. A method according to claim 1 further comprising:
constructing a surface flow parameter profile from the surface flow parameter data, the surface flow parameter profile being a functional relationship between surface flow parameter value and distance from a reference point on the body.

5. A method according to claim 4 wherein the action of determining the LESP location includes:
determining a body point location associated with a minimum point on the surface flow parameter profile; and
establishing the LESP location as the body point location associated with the minimum point on the surface flow parameter profile.

6. A method according to claim 4 wherein the action of determining the angle of attack includes:
identifying local extrema on the flow parameter profile;
determining body point locations associated with the local extrema on the o parameter profile to provide a set of extrema locations; and
calculating the angle of attack using the set of extrema locations.

7. A method according to claim 6 wherein the action of calculating the angle of attack includes:
comparing the set of extrema locations to known extrema location sets, each known extrema location set being associated with a known combination of angle of attack and LESP.

8. A method according to claim I wherein the action of determining the angle of attack includes receiving angle of attack information from one of the set consisting of an air data probe and an inertial measurement system.

9. A method according to claim 1 wherein the aerodynamic model comprises a mathematical relationship between the aerodynamic coefficient, the LESP and the angle of attack for the set of flow conditions.

10. A method according to claim 9 wherein the mathematical relationship is derived only from experimental data from instrumented bodies subjected to the set of flow conditions.

11. A method according to claim 1 wherein the aerodynamic model incorporates an inviscid flow model adjusted according to an adjustment function determined from experimental data from instrumented bodies subjected to the set of flow conditions.

12. A method according to claim 11 wherein the adjustment function provides change in aerodynamic coefficient as a function of LESP recession for a given angle of attack, LESP recession being a difference between LESP calculated using the inviscid flow model and experimentally determined LESP for a given set of conditions.

13. A system for determining an aerodynamic coefficient for a body immersed in a fluid under a set of fluid flow conditions, said flow conditions establishing a leading edge stagnation point (LESP) at an LESP location on the body, the system comprising:
a data processor including
an input receiving portion adapted for receiving surface flow parameter data for a plurality of locations on the body, said locations including body surface points straddling an area of the body surface where the LESP is expected to be located;
a flow mapping portion adapted for constructing a surface flow parameter profile from the surface flow parameter data, the surface flow parameter profile being a functional relationship between surface flow parameter value and distance from a reference point on the body, and
an aerodynamic model calculation portion adapted for determining the aerodynamic coefficient based on the surface flow parameter profile.

14. A system according to claim 13 wherein the flow mapping portion is also adapted to determine from the surface flow parameter data one or more of the set consisting of the LESP and an angle of attack of the body with respect to freestream conditions.

15. A system according to claim 13 wherein the input receiving portion is also adapted for receiving flow parameter data for the flow conditions and wherein the data processor also includes
a load determination portion adapted for calculating a load on the body using the flow parameter data and the aerodynamic coefficient.
